(19) United States
(12) Patent Application Publication
(10) Pub. No.: US 2025/0296745 A1
(43) Pub. Date: Sep. 25, 2025

(54) PRESSURE RELIEF SYSTEM FOR ENCLOSURES

(71) Applicant: ROCKWELL AUTOMATION TECHNOLOGIES, INC., MAYFIELD HEIGHTS, OH (US)

(72) Inventors: James K. Newbern, Slinger, WI (US); Dean T. Meyer, Oak Creek, WI (US); Alissa K. Shortreed, Milwaukee, WI (US); Kurt R. Mickler, Waukesha, WI (US); Robert S. Dilgard, Shorewood, WI (US); David M. Amidon, Caledonia, WI (US)

(21) Appl. No.: 18/614,141

(22) Filed: Mar. 22, 2024

(51) Int. Cl. B65D 51/16; B65D 53/00; H05K 7/14

(52) U.S. Cl. CPC B65D 51/1638; B65D 53/00; H05K 7/1462

(57) ABSTRACT

An enclosure, such as, for example, a motor control center (MCC) used in an industrial automation environment, designed to provide pressure relief and ingress protection. The enclosure includes an opening, an optional gasket disposed over the opening, and a pressure relief plate disposed over the gasket including tabs that secure the pressure relief plate to the enclosure. The tabs are adapted to fracture upon a change in pressure within the enclosure to allow the pressure relief plate to open, and thereby to allow pressure to escape from the enclosure responsive to the change in pressure within the enclosure.

### BACKGROUND INFORMATION

This disclosure relates generally to the field of enclosures, such as enclosures for motor control centers used in various types of industrial automation environments. More particularly, the disclosure relates to enclosures designed with pressure relief, ingress protection, and arc resistant features.

### BRIEF DESCRIPTION

One aspect of the disclosure is an enclosure. The enclosure includes an opening, a gasket disposed over the opening, and a pressure relief plate disposed over the gasket. The pressure relief plate includes tabs that secure the pressure relief plate to the enclosure, and the tabs are adapted to fracture upon a change in pressure within the enclosure to allow the pressure relief plate to open and thereby to allow pressure to be directed and escape from the enclosure responsive to the change in pressure within the enclosure.

Another aspect of the disclosure is another enclosure. The enclosure includes an opening, a top plate disposed over the opening and including a plurality of perforated openings, a gasket disposed over the top plate, and a pressure relief plate disposed over the gasket. The pressure relief plate includes tabs that secure the pressure relief plate to the enclosure, and the tabs are adapted to fracture upon a change in pressure within the enclosure to allow the pressure relief plate to open and thereby to allow pressure to be directed and escape from the enclosure responsive to the change in pressure within the enclosure.

Yet another aspect of the disclosure is yet another enclosure. The enclosure includes an opening, a top plate disposed over the opening and including a plurality of perforated openings, and a pressure relief plate disposed over the top plate. The pressure relief plate includes tabs that secure the pressure relief plate to the enclosure, and the tabs are adapted to fracture upon a change in pressure within the enclosure to allow the pressure relief plate to open and thereby to allow pressure to be directed and escape from the enclosure responsive to the change in pressure within the enclosure.

### BRIEF DESCRIPTION OF THE DRAWINGS

FIG. 1 is a perspective illustration showing an example motor control center (MCC) for use in an industrial automation environment, in accordance with some aspects of the disclosure.

FIG. 2 is a perspective illustration showing components of an example top pressure relief system that can be used with the MCC of FIG. 1, in accordance with some aspects of the disclosure.

FIG. 3 is a perspective illustration showing example tabs that can be used in the top pressure relief system of FIG. 2, in accordance with some aspects of the disclosure.

FIG. 4 is a perspective illustration showing an example pressure relief plate that can be used in the top pressure relief system of FIG. 2, in accordance with some aspects of the disclosure.

FIG. 5 is a perspective illustration showing an example response of the top pressure relief system of FIG. 2 to a change in pressure within the MCC of FIG. 1, in accordance with some aspects of the disclosure.

FIG. 6 is a perspective illustration showing an example vertical surface, specifically an example unit door and an associated opening, that can be included in the MCC of FIG. 1, in accordance with some aspects of the disclosure.

FIG. 7 is a perspective illustration showing an example vertical surface pressure relief system that can be used with the unit door of FIG. 6, in accordance with some aspects of the disclosure.

FIG. 8 is a perspective illustration showing the vertical surface pressure relief system of FIG. 7 secured to the unit door of FIG. 6, in accordance with some aspects of the disclosure.

FIG. 9 is a perspective illustration showing an example cover that can be part of the vertical surface pressure relief system of FIG. 7, in accordance with some aspects of the disclosure.

FIG. 10 is a perspective illustration showing an example response of the vertical surface pressure relief system of FIG. 7 to a change in pressure within the MCC of FIG. 1, in accordance with some aspects of the disclosure.

FIG. 11 is another perspective illustration showing an example response of the vertical surface pressure relief system of FIG. 7 to a change in pressure within the MCC of FIG. 1, in accordance with some aspects of the disclosure.

FIG. 12 is a perspective illustration showing a removable utility enclosure that can be secured to a side of the MCC of FIG. 1, in accordance with some aspects of the disclosure.

FIG. 13 is another perspective illustration showing the removable utility enclosure of FIG. 12, in accordance with some aspects of the disclosure.

FIG. 14 is yet another perspective illustration showing the removable utility enclosure of FIG. 12 installed on a left end of the MCC of FIG. 1, in accordance with some aspects of the disclosure.

### DETAILED DESCRIPTION

A particular challenge in the design and operation of electrical components in enclosures relates to designing the enclosures to withstand the mechanical and thermal effects of an internal arcing fault (also called an arc, arc fault, arc flash, arcing flash, etc.). For example, certain types of electrical faults can produce arcs that can heat and even vaporize neighboring components and cause sudden pressure increases and localized overheating. While development of protective circuitry has focused on interrupting such faults extremely quickly, even a few cycles of alternating current can suffice to vaporize wires, insulation, and even component housings. Such faults can result in volumes of hot gas that expand and must be channeled and/or vented within or from the enclosure. Further, the faults can produce high temperatures and pressure increases that cause mechanical and thermal stresses on enclosures. Arcing faults can cause damage to equipment and facilities and increase costs due to lost production. Accordingly, industrial standards and guides have been developed as a way for manufacturers to demonstrate that the enclosures can withstand the mechanical and thermal effects of an internal arcing fault. The disclosure relates generally to the field of enclosures, such as enclosures for motor control centers used in industrial and commercial settings. More particularly, aspects of the disclosure relate to enclosures designed with arc resistant features. Additional aspects pertaining to arc resistant enclosures are further described in U.S. patent application Ser. No. 13/075,698, filed Mar. 30, 2011, the entire disclosure of which is incorporated by reference herein.

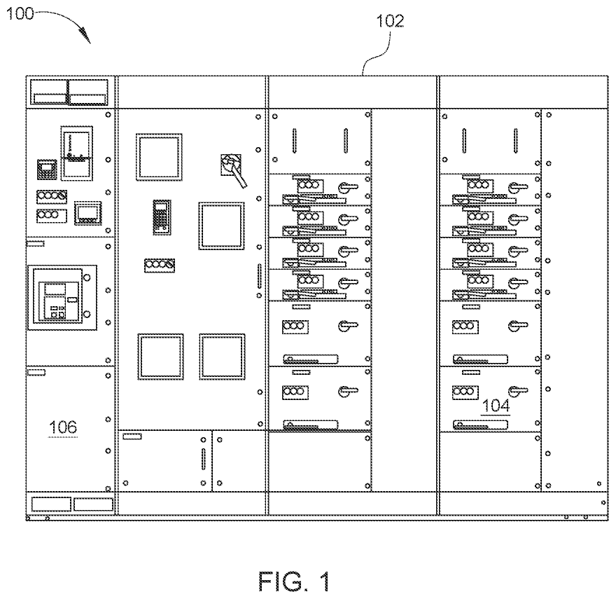

Referring to FIG. 1, a perspective illustration showing an example motor control center (MCC) 100 for use in an industrial automation environment is shown, in accordance with some aspects of the disclosure. The MCC 100 provides an example of an enclosure that aspects of the disclosure can be implemented in. The MCC 100 can be a low voltage motor control center such as, for example, a FLEXLINE® 3500 MCC, a CENTERLINE® 2500 MCC, or a CENTERLINE® 2100 MCC as provided by Rockwell Automation, Inc., among other types of MCCs. Aspects of the disclosure can also be implemented in other types of enclosures such as, for example, a modular enclosure that can be used in an MCC (e.g., the MCC 100), and/or other types of enclosures that can be used in an industrial automation environment or elsewhere. For example, various aspects of the disclosure can be implemented in enclosures used in manufacturing facilities in industries such as aerospace, automotive, cement, chemical processing, food and beverage, household and personal care, life sciences, marine operations, metals processing, mining operations, oil and gas, power generation, print and publishing, pulp and paper, semiconductors, warehouse and fulfillment, and wastewater treatment, among others that may benefit from pressure relief features.

As shown in FIG. 1, the MCC 100 includes a top surface 102 on which an example top pressure relief system can be implemented, as detailed further below. The top surface 102 can vary upon the specific implementation of the MCC 100. For example, the top surface 102 may be continuous, may not be continuous, may be defined by various units of the MCC 100 (e.g., units installed in a top row of the MCC 100). In any event, the top surface 102 can be used to relieve pressure that builds up within the MCC 100 (e.g., in response to an arc fault event). The MCC 100 is also shown in FIG. 1 to include both a modular unit door 104 and a modular unit door 106. The modular unit door 104, as shown, includes various interactive components such as a handle, a rotary dial, and a series of push buttons. The modular unit door 104 can be opened to access equipment in the associated modular unit of the MCC 100. For example, the modular unit can include components such as relays, motor starters, circuit breakers, variable frequency drives, programmable logic controllers (PLCs), etc. that provide functionality for controlling a system and/or process. The MCC 100 can include various modular units as shown in FIG. 1. For example, a modular unit door 106 is also shown as part of the MCC 100 in FIG. 1. The modular unit door 106 can similarly be opened to access equipment in the associated modular unit of the MCC 100. Additionally, the modular unit associated with the modular unit door 106 is located on a left side of the MCC 100. The MCC 100 can also include modular units including modular doors located on any vertical surface of the MCC 100, including front, side, and/or rear surfaces of the MCC 100.

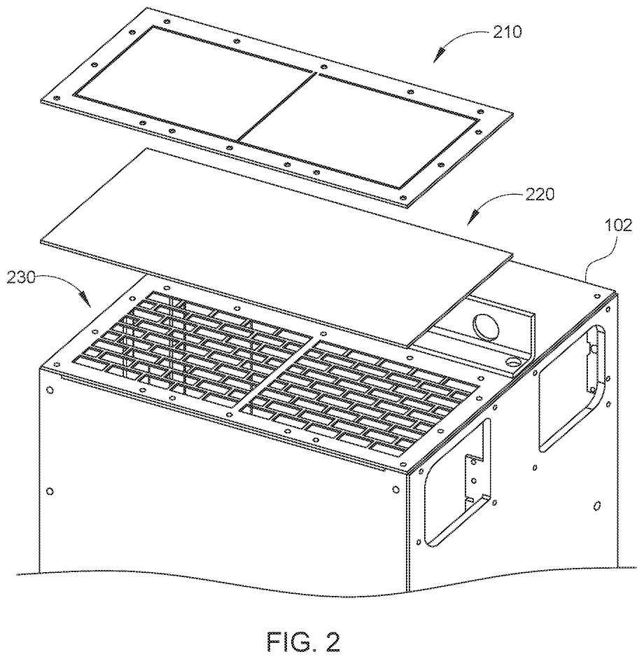

Referring to FIG. 2, a perspective illustration showing components of an example top pressure relief system that can be used with the MCC 100 is shown, in accordance with some aspects of the disclosure. As shown, the top pressure relief system includes a pressure relief plate 210, a gasket 220, and a top plate 230. The top plate 230 can be disposed on the top surface 102 of the MCC 100. For example, the top plate 230 can be secured to the top surface 102 of the MCC 100 using various types of fasteners (e.g., screws, bolts, etc.) and/or other securing mechanisms. The top plate 230 can, more specifically, be secured to the top surface 102 of the MCC 100 such that the top plate 230 is disposed over an opening in the top surface 102 of the MCC 100. Then, the gasket 220 can be secured to the top plate 230. For example, the gasket 220 can include a top surface and a bottom surface, and the bottom surface of the gasket 220 can include adhesive. The bottom surface of the gasket 220 can then be secured to the top plate 230 via the adhesive. Various types of adhesive materials can be used depending on the application. The use of adhesive in this manner can allow for quick and easy installation of the gasket 220 as part of the top pressure relief system for the MCC 100. Then, the pressure relief plate 210 can be secured to the MCC 100 over the gasket 220 such that a bottom surface of the pressure relief plate 210 contacts the top surface of the gasket 220. The pressure relief plate 210 can be secured to the MCC 100 using various types of fasteners (e.g., screws, bolts, etc.) and/or other securing mechanisms. The pressure relief plate 210 can be formed of various suitable materials and/or combinations of materials, such as aluminum, steel, and/or other materials.

The top plate 230 can include a plurality of perforated openings as shown in FIG. 2. The top plate 230 can also be adapted to protect live conductors within the MCC 100 upon opening of the pressure relief plate 210 responsive to a change in pressure that occurs within the MCC 100 (e.g., responsive to an arc fault event, etc.). Further, the top plate 230 can be adapted to provide compliance with applicable safety standards, such as, for example, safety standards maintained by the United States Occupational Safety and Health Administration (OSHA), UL, the International Electrotechnical Commission (IEC), the Institute of Electrical and Electronics Engineers (IEEE), and/or the National Electrical Manufacturers Association (NEMA), among others, upon opening of the pressure relief plate 210 responsive to a change in pressure that occurs within the MCC 100. The perforated openings in the top plate 230 can be designed, for example, to exclude entry of a test rod to comply with various regulations and safety standards (e.g., from OSHA, UL, and/or IEC). For example, the perforated openings in the top plate 230 can be between 0.65 inches and 0.7 inches wide to exclude entry of a 49/64 (0.766) inch test rod. The perforated openings in the top plate 230 can also be between 1.5 inches and 1.6 inches long, and a space between each of the perforated openings in the top plate 230 can also be between 0.14 inches and 0.18 inches. Further, the perforated openings in the top plate 230 can be formed in offsetting rows, where the rows can be offset by between 0.65 inches and 0.75 inches, in some examples. The perforated openings in the top plate 230 can be formed using various manufacturing methods applicable to the material. The top plate 230 can be formed of various suitable materials and/or combinations of materials, such as, for example, aluminum, steel, and/or other materials.

The gasket 220 can be used as part of the top pressure relief system of the MCC 100 to provide ingress protection functionality. As such, the gasket 220 can facilitate compliance with various standards and regulations. For example, the use of the gasket 220 in the MCC 100 can provide certified protection against dust and liquid ingress (e.g., in accordance with applicable standards and regulations and/or specifications desired by the end user). The gasket 220 can be formed using various different types and combinations of sealing materials, such as, for example, neoprene rubber and/or other suitable types of materials, including materials typically recognized by various safety standards (e.g., by UL, IEC, etc.). The gasket 220 can notably be adapted to tear upon opening of the pressure relief plate 210 responsive to a change in pressure that occurs within the MCC 100 (e.g., responsive to an arc fault event, etc.) to help relieve and direct pressure from inside the MCC 100. As noted, the bottom surface of the gasket 220 can include an adhesive to provide quick and easy installation of the gasket 220 over the top plate 230. The gasket 220 can, in some implementations where alternate ingress protection functionality is desired, be excluded from the top pressure relief system of the MCC 100 such that the pressure relief plate 210 is secured to the top plate 230 without the gasket 220 in between. For example, when the gasket 220 is removed, compliance with various standards, regulations, and/or end user specifications can still be achieved in some implementations.

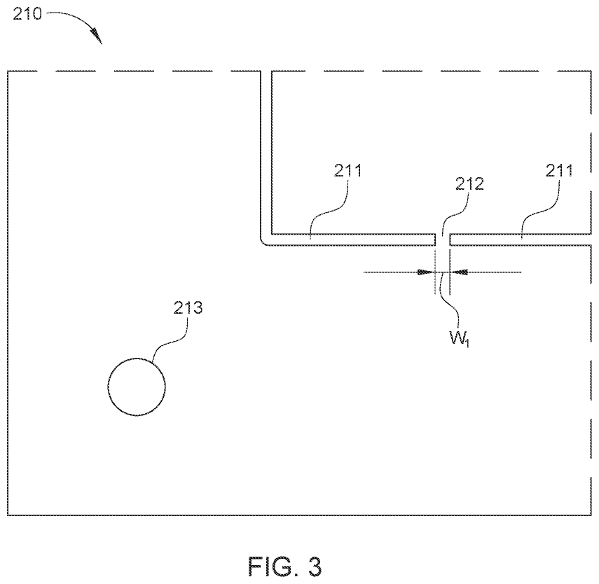

Referring to FIG. 3, a perspective illustration showing example tabs 212 that can be used in the top pressure relief system of the MCC 100 is shown, in accordance with some aspects of the disclosure. The tabs 212 can be formed within the pressure relief plate 210 such that the tabs 212 are adapted to fracture upon a change in pressure within the MCC 100 (e.g., responsive to an arc fault event, etc.) to allow the pressure relief plate 210 to open, and thereby to allow pressure to escape from the MCC 100 responsive to the change in pressure within the MCC 100. As shown in FIG. 3, the tabs 212 can be formed within the pressure relief plate 210 such that the tabs 212 are disposed between openings 211 that are formed in the pressure relief plate 210. For example, various types of manufacturing approaches can be used to precisely form the openings 211 within the pressure relief plate 210 by removing material from the pressure relief plate 210. As shown in FIG. 3, the pressure relief plate 210 can also include holes 213 that can be used to fasten the pressure relief plate 210 to the MCC 100 (e.g., using various types of fasteners such as screws, bolts, etc.). The use of the tabs 212 within the pressure relief plate 210 can provide advantages in terms of alleviating bowing that may occur between fasteners inserted into the holes 213 responsive to the change in pressure within the MCC 100.

The design of the tabs 212, including the dimensional characteristics of the tabs 212, can vary by enclosure type and the end user safety and/or environment specifications. For example, the design of the tabs 212 and/or the openings 211 can be adjusted to achieve desired performance in terms of allowing pressure to escape from a given enclosure. Even if one of the tabs 212 fractures before a change in pressure occurs (e.g., before an arc fault event, etc.), the top pressure relief system can still meet various safety standards and/or provide protection against liquid and dust ingress. As shown in FIG. 3, the tabs 212 can have a width W1 as measured between two of the adjacent openings 211. The width W₁ of the tabs 212 formed in the pressure relief plate 210 as measured between two of the adjacent openings 211 can be between 0.05 inches and 0.07 inches, in some examples.

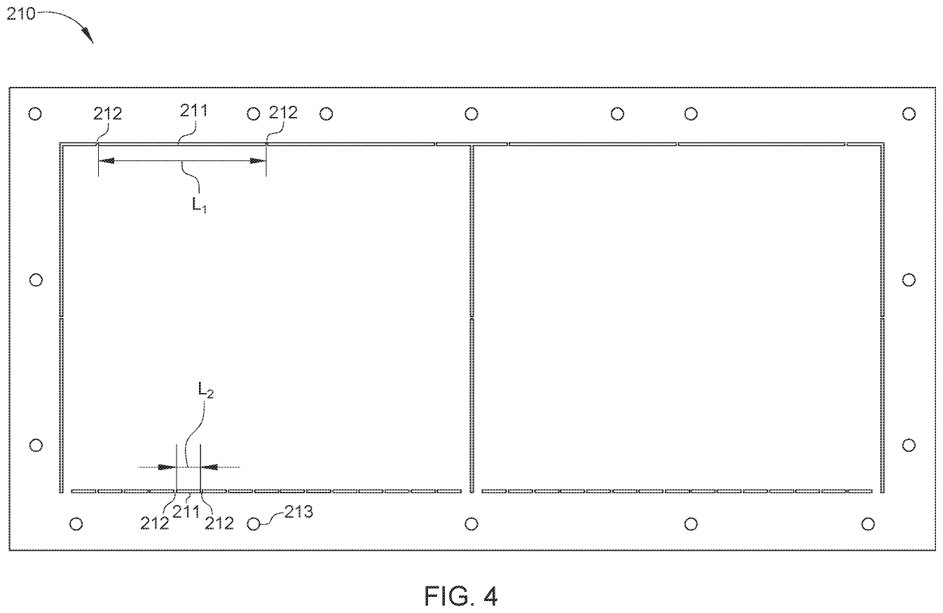

Referring to FIG. 4, a perspective illustration showing the example pressure relief plate 210 that can be used in the top pressure relief system of the MCC 100 is shown, in accordance with some aspects of the disclosure. The illustration shown in FIG. 4 provides just one example configuration of the openings 211, the tabs 212, and the holes 213 within the pressure relief plate 210. As shown, the openings 211 can include at least two different types of openings including a first type of opening and a second type of opening. The first type of opening can be a “hinge” type opening that is longer than the second type of opening. The hinge slots in particular can be used in the pressure relief plate 210 to enable easier opening of the pressure relief plate 210 responsive to a change in pressure that occurs within the MCC 100 (e.g., responsive to an arc fault event, etc.) to help pressure escape from the MCC 100. In some examples, the first type of the openings 211 can have a first length L₁ as measured between two of the adjacent tabs 212 formed in the pressure relief plate 210, as shown in FIG. 4. Also, in some examples, the second type of the openings 211 can have a second length L2 as measured between two of the adjacent tabs 212 formed in the pressure relief plate 210, as also shown in FIG. 4. The first length L₁ of the first type of the openings 211 can be between 3.55 and 3.75 inches, whereas the second length L2 of the second type of the openings 211 can be between 0.45 and 0.55 inches, in some examples.

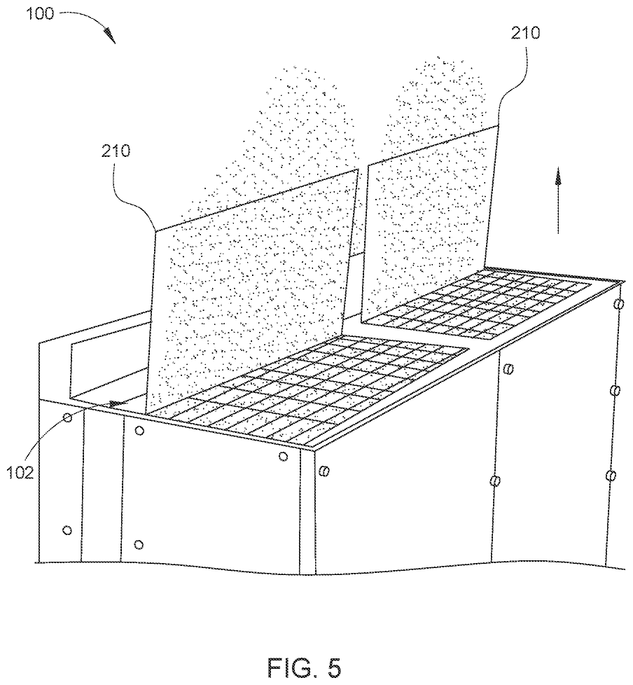

Referring to FIG. 5, a perspective illustration showing an example response of the top pressure relief system of the MCC 100 to a change in pressure that occurs within the MCC 100 to help pressure escape from the MCC 100 is shown, in accordance with some aspects of the disclosure. As shown, the top pressure relief plate 210 opens responsive to the change in pressure that occurs within the MCC 100 (e.g., responsive to an arc fault event, etc.), and the pressure escapes through the top of the MCC 100 (e.g., through the top surface 102). Various gases, flames, and other substances can also escape through the top of the MCC 100 in response to an arc fault. As noted, the gasket 220 can also tear upon opening of the pressure relief plate 210.

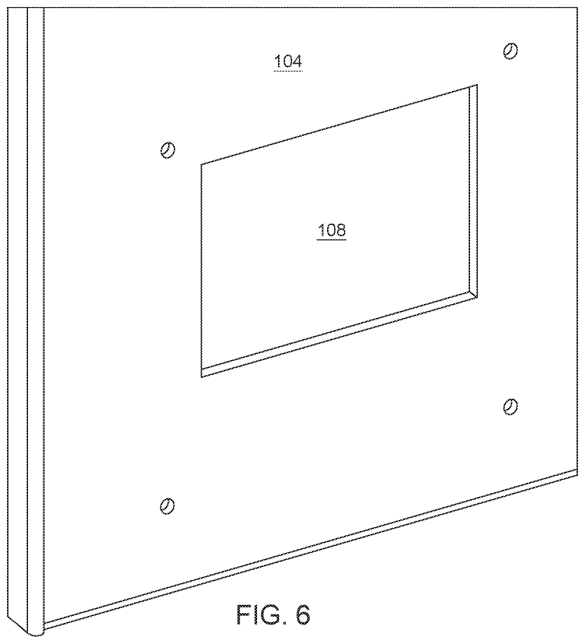

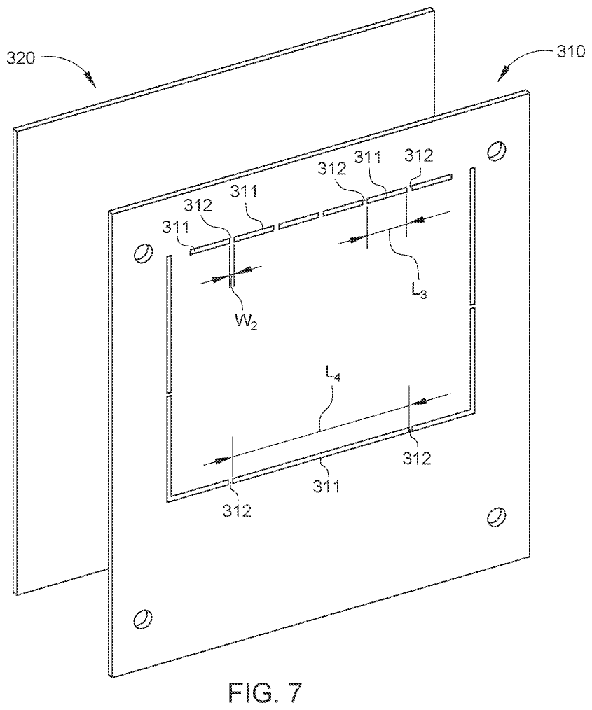

Referring to FIG. 6, a perspective illustration showing the example unit door 104 and an associated opening 108 is shown, in accordance with some aspects of the disclosure. As will be detailed below, a vertical surface pressure relief system including similar components to the top pressure relief system discussed above can be installed over the opening 108 to allow pressure to escape from the modular unit of the MCC 100 associated with the unit door 104 upon a change in pressure within the MCC 100 and/or within the modular unit of the MCC 100 associated with the unit door 104 (e.g., responsive to an arc fault event, etc.). The opening 108 in the unit door 104 can have various configurations and dimensions depending on the application. The vertical surface pressure relief system detailed below with respect to FIGS. 7-10 can be used to provide a close, direct path for pressure and gasses to escape from the MCC 100 from a unit. In some scenarios, it may be difficult to get all/most of the pressure associated with an arc fault event to escape through the top of the MCC 100, so using the vertical surface pressure relief system detailed below either on its own or in combination with the top pressure relief system detailed above can provide advantages in such scenarios. While the vertical surface pressure relief system is described in the disclosure as being implemented on the unit door 104, the vertical surface pressure relief system including the pressure relief plate 310, the optional gasket 320, and the cover 340 can be installed on a variety of types of vertical surfaces (e.g., surfaces that are generally perpendicular with the ground) on a variety of types of enclosures.

Referring to FIG. 7, a perspective illustration showing example components of the vertical surface pressure relief system that can be installed on the unit door 104 is shown, in accordance with some aspects of the disclosure. As shown, the vertical surface pressure relief system can include both a gasket 320 and a pressure relief plate 310. The gasket 320 and the pressure relief plate 310 can be similar to the gasket 220 and the pressure relief plate 210, respectively, as detailed above with respect to the top pressure relief system. For example, as shown in FIG. 7, the pressure relief plate 310 can include tabs 312 that are similar to the tabs 212, and openings 311 that are similar to the openings 211. The vertical surface pressure relief system can also include a vented cover as detailed further below. The pressure relief plate 310 can be formed using various suitable materials and/or combinations of materials, such as, for example, aluminum, steel, and/or other materials.

The gasket 320 can be used as part of the vertical surface pressure relief system provide ingress protection functionality and facilitate compliance with various standards and regulations. For example, the use of the gasket 320 can provide certified protection against dust and liquid ingress (e.g., in accordance with applicable standards and regulations and/or specifications desired by the end user). The gasket 320 can be formed using various different types and combinations of scaling materials, such as, for example, neoprene rubber and/or other suitable types of materials, including materials recognized by various safety standards (e.g., by UL, IEC, etc.). The gasket 320 can notably be adapted to tear upon opening of the pressure relief plate 310 responsive to a change in pressure (e.g., responsive to an arc fault event, etc.) to help pressure escape through the unit door 104. The bottom surface of the gasket 320 can include an adhesive to provide quick and easy installation of the gasket 320 on the unit door 104 of the MCC 100. The gasket 320 can, in some implementations where alternate ingress protection functionality is desired, be excluded from the vertical surface pressure relief system such that the pressure relief plate 310 is secured to the unit door 104 without the gasket 320 in between. For example, when the gasket 320 is removed, compliance with various standards, regulations, and/or end user specifications can still be achieved in some implementations.

The tabs 312 can again be formed within the pressure relief plate 310 such that the tabs 312 are adapted to fracture upon a change in pressure within the MCC 100 (e.g., responsive to an arc fault event that occurs within the modular unit, etc.) to allow the pressure relief plate 310 to open, and thereby to allow pressure to escape from the MCC 100 through the unit door 104 responsive to the change in pressure. As shown in FIG. 7, the tabs 312 can be formed within the pressure relief plate 310 such that the tabs 312 are disposed between the openings 311 that are formed in the pressure relief plate 310. For example, various manufacturing methods can be used to precisely form the openings 311 within the pressure relief plate 310 by removing material from the pressure relief plate 310. As shown in FIG. 7, the pressure relief plate 310 can also include holes that can be used to fasten the pressure relief plate 310 to the unit door 104 (e.g., using various types of fasteners such as screws, bolts, etc.). The use of the tabs 312 within the pressure relief plate 310 can provide advantages in terms of alleviating bowing that may occur between fasteners inserted into these holes responsive to the change in pressure within the MCC 100. Even if one of the tabs 312 fractures before a change in pressure occurs (e.g., before an arc fault event, etc.), the vertical surface pressure relief system can still meet various safety standards and/or provide protection against liquid and dust ingress.

The illustration of the pressure relief plate 310 as shown in FIG. 7 provides just one example configuration of the openings 311, the tabs 312, and the holes within the pressure relief plate 310. As shown, the openings 311 can again include at least two different types of openings, including a first type of opening and a second type of opening. The first type of opening can be a hinge type opening that is longer than the second type of opening. The hinge slots in particular can be used in the pressure relief plate 310 to enable easier opening of the pressure relief plate 310 responsive to a change in pressure (e.g., responsive to an arc fault event, etc.) to help pressure escape through the unit door 104. As shown in FIG. 7, the tabs 312 formed in the pressure relief plate 310 can have a width W2 as measured between two of the adjacent openings 311. Also shown in FIG. 7, the first type of the openings 311 formed in the pressure relief plate 310 can have a fourth length La as measured between two of the adjacent tabs 312 formed in the pressure relief plate 310, and the second type of the openings 311 formed in the pressure relief plate 310 can have a third length L3 as measured between two of the adjacent tabs 312 formed in the pressure relief plate 310.

The design of the tabs 312, including the dimensional characteristics of the tabs 312, can vary by enclosure type and the end user safety and/or environment specifications. For example, the design of the tabs 312 and/or the openings 311 can be adjusted to achieve desired performance in terms of allowing pressure to escape from a given enclosure. The pivot points of the pressure relief plate 310 can be oriented at the top (from the perspective view shown in FIG. 7) to direct pressure and gasses downward. The width W2 of the tabs 312 formed in the pressure relief plate 310 as measured between two of the adjacent openings 311 can be between 0.05 inches and 0.07 inches, in some examples. The fourth length La of the first type of the openings 311 formed in the pressure relief plate 310 as measured between two of the adjacent tabs 312 formed in the pressure relief plate 310 can be between 2.2 and 2.4 inches, and the third length L3 of the second type of the openings 311 formed in the pressure relief plate 310 as measured between two of the adjacent tabs 312 formed in the pressure relief plate 310 can be between 0.45 and 0.55 inches, in some examples.

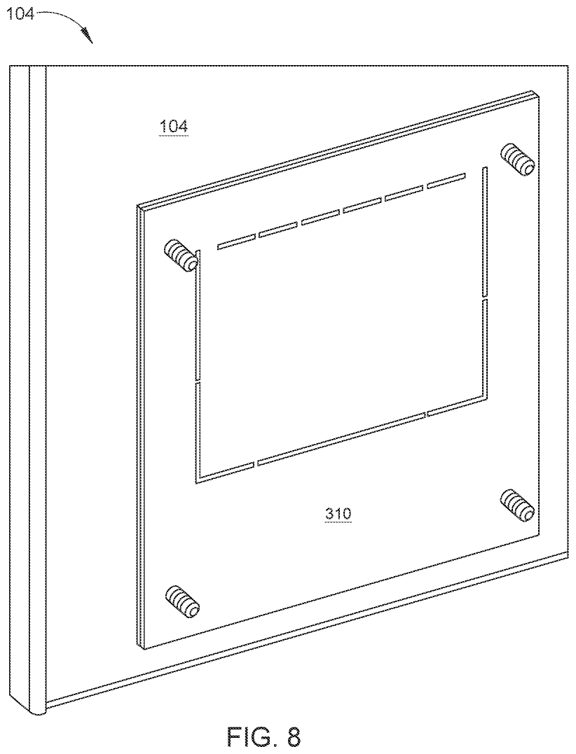

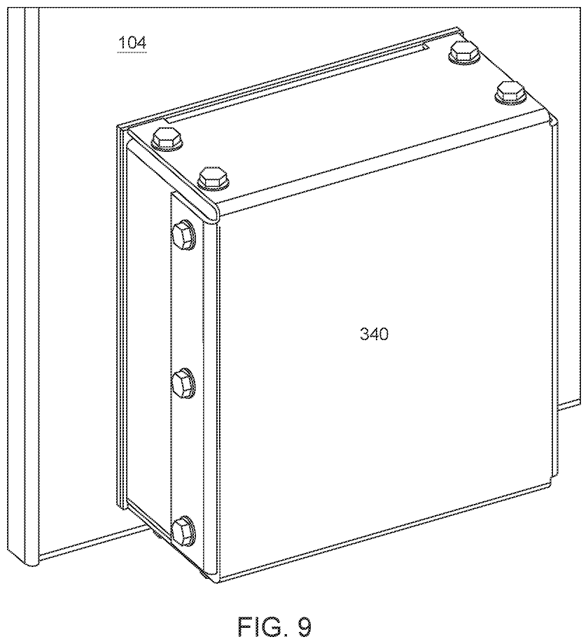

Referring to FIG. 8, a perspective illustration showing an example of the pressure relief plate 310 when secured to the unit door 104 is shown, in accordance with some aspects of the disclosure. Referring to FIG. 9, a perspective illustration showing an example cover 340 that can be secured to the unit door 104 as part of the vertical surface pressure relief system is shown, in accordance with some aspects of the disclosure. The cover 340 can be formed of different parts, including two side plates and a front cover, for example. The cover 340 can include five generally flat exposed surfaces: a top surface, a left surface, a right surface, a bottom surface, and an outer surface. Each of these surfaces besides the bottom surface can be sealed such that they do not permit transfer of gases or other objects that may release from the MCC 100 responsive to a change in pressure (e.g., responsive to an arc fault event, etc.).

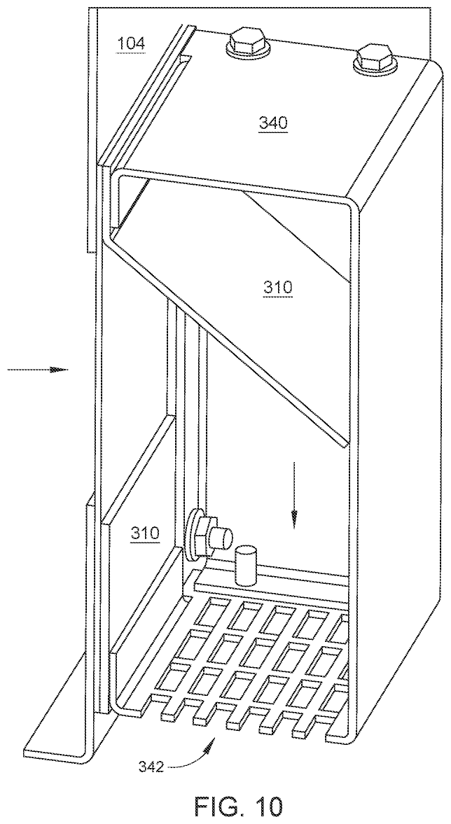

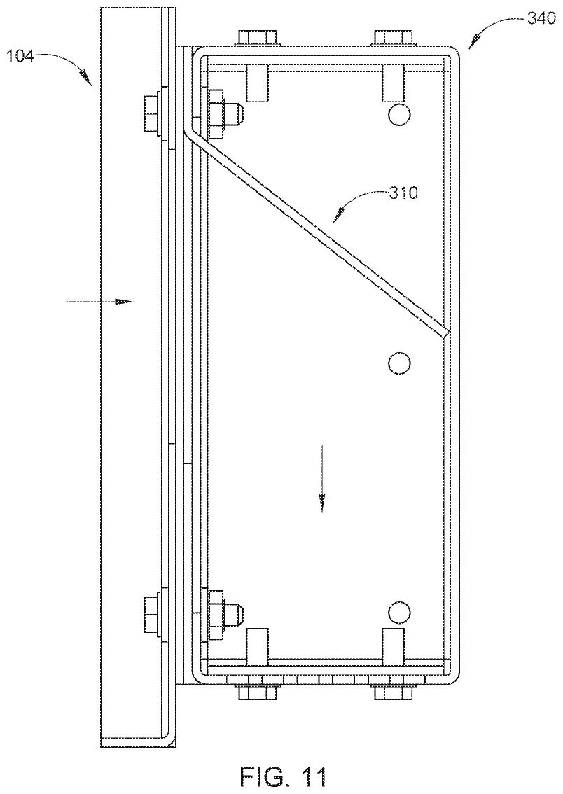

Referring to FIG. 10, a perspective illustration showing an example bottom vent 342 of the cover 340 and an example response of the vertical surface pressure relief system to a change in pressure within the MCC 100 is shown, in accordance with some aspects of the disclosure. As shown, the bottom vent 342 can be formed within the bottom surface of the cover 340 to permit passage of pressure and gasses to escape from the MCC 100 through the unit door 104 and through the bottom vent 342. The bottom vent 342 can included a plurality of perforated openings. The perforated openings, in some examples, can have a width between 0.55 and 0.65 inches and a height between 0.15 and 0.25 inches. However, the design of the perforated openings, including the dimensional characteristics of the perforated openings, can vary by enclosure type and the end user safety and/or environment specifications. Also shown in FIG. 10, responsive to a change in pressure (e.g., responsive to an arc fault event, etc.), the tabs 312 of the pressure relief plate 310 fracture, thereby permitting the pressure relief plate 310 to open and to guide the excess pressure to escape through the bottom vent 342. In such a scenario, if the gasket 320 is included in the vertical surface pressure relief system, the gasket 320 can tear open. Referring to FIG. 11, another perspective illustration showing an example response of the vertical surface pressure relief system to a change in pressure within the MCC 100 is shown, in accordance with some aspects of the disclosure. The top pressure relief system and/or the vertical surface pressure relief system can be used to provide compliance with various safety standards and regulations (e.g., from OSHA, UL, IEC, IEEE, etc.).

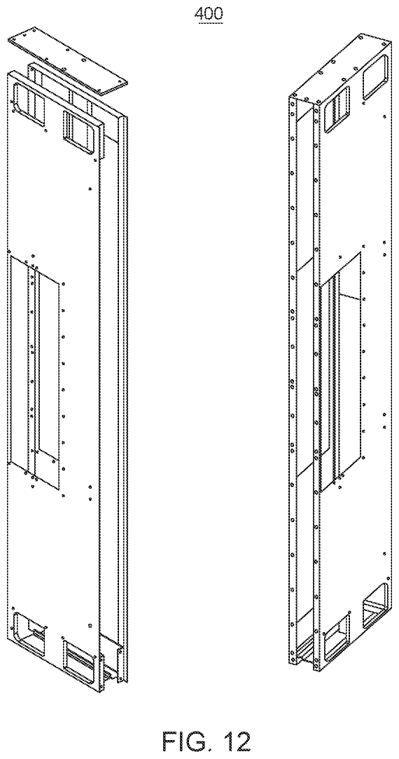

Referring to FIG. 12, a perspective illustration showing a removable utility enclosure 400 that can be secured to a side of the MCC 100 is shown, in accordance with some aspects of the disclosure. The utility enclosure 400 can be connectable to and removable from the MCC 100 to provide increased structural rigidness (e.g., during an arc fault event, etc.) and to help route pressure and/or gasses appropriately within the MCC 100. For example, the utility enclosure 400 can help route pressure and/or gasses through the MCC 100 towards the pressure relief plate 210. The utility enclosure 400 can be between 4.5 and 5.5 inches wide, in some examples. The utility enclosure 400 can further include various configurations of openings, brackets and other mechanical components designed to help route pressure and/or gasses appropriately within the MCC 100. The utility enclosure can be installed on an end of the MCC 100, such as, for example, on the end of the modular unit of the MCC 100 associated with the unit door 106. The utility enclosure 400 can essentially act as an “airbag” that absorbs pressure and routes is appropriately within the MCC 100. The utility section 400 can be used with various types of enclosures beyond the MCC 100.

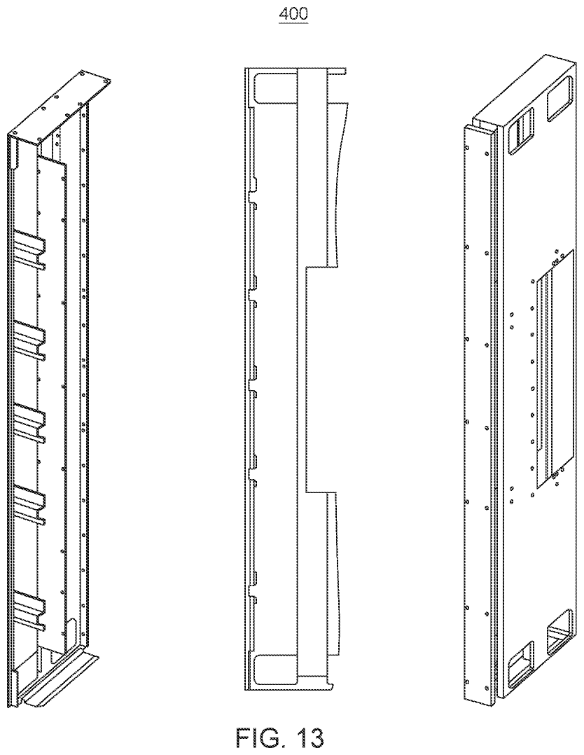

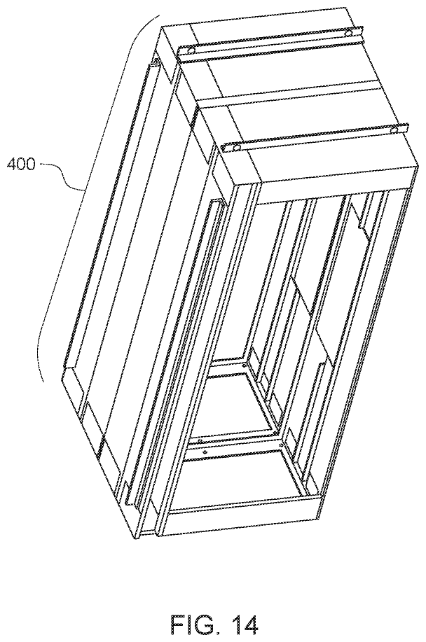

Referring to FIG. 13, another perspective illustration showing the example removable utility enclosure 400 is shown, in accordance with some aspects of the disclosure. Referring to FIG. 14, yet another perspective illustration showing the example removable utility enclosure 400 is shown, in accordance with some aspects of the disclosure. FIG. 14 in particular shows the utility enclosure 400 when installed on an end of the MCC 100 (e.g., as shown on the left end of the modular unit of the MCC 100 associated with the unit door 106). A horizontal bus can also be installed on the utility enclosure 400 to facilitate electrical connections within the MCC 100.

This description uses examples to disclose the invention and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An enclosure, comprising:
an opening;
a gasket disposed over the opening; and
a pressure relief plate disposed over the gasket and comprising tabs that secure the pressure relief plate to the enclosure, the tabs adapted to fracture upon a change in pressure within the enclosure to allow the pressure relief plate to open and thereby to allow pressure to be directed and escape from the enclosure responsive to the change in pressure within the enclosure.

2. The enclosure of claim 1, wherein the tabs are disposed between openings formed in the pressure relief plate.

3. The enclosure of claim 2, wherein a width of the tabs as measured between two of the adjacent openings formed in the pressure relief plate is between 0.05 inches and 0.07 inches.

4. The enclosure of claim 3, wherein the openings formed in the pressure relief plate comprise at least a first type of opening having a first length as measured between two of the adjacent tabs of the pressure relief plate and a second type of opening having a second length as measured between two of the adjacent tabs of the pressure relief plate, the first length longer than the second length.

5. The enclosure of claim 1, wherein the pressure relief plate is formed of aluminum or steel.

6. The enclosure of claim 1, comprising a top plate disposed between the gasket and the opening, the top plate comprising a plurality of perforated openings and adapted to protect live conductors within the enclosure upon opening of the pressure relief plate responsive to the change in pressure within the enclosure.

7. The enclosure of claim 1, wherein the gasket is adapted to tear upon opening of the pressure relief plate responsive to the change in pressure within the enclosure.

8. The enclosure of claim 1, wherein the gasket comprises a top surface and a bottom surface closest to the opening, the bottom surface comprising an adhesive to secure the gasket to the enclosure.

9. The enclosure of claim 1, comprising a removable utility enclosure secured to a side of the enclosure and adapted to route pressure towards the pressure relief plate responsive to the change in pressure within the enclosure.

10. The enclosure of claim 1, wherein:
the enclosure comprises a motor control center; and
the opening is disposed within a top surface of the motor control center.

11. The enclosure of claim 1, wherein:
the enclosure comprises a motor control center;
the opening is disposed within a vertical surface of the motor control center; and
a cover is disposed over the pressure relief plate, the cover comprising a second opening disposed in a bottom surface of the cover, the second opening adapted to allow the pressure to escape from the enclosure through the second opening.

12. An enclosure, comprising:
an opening;
a top plate disposed over the opening and comprising a plurality of perforated openings;
a gasket disposed over the top plate; and
a pressure relief plate disposed over the gasket and comprising tabs that secure the pressure relief plate to the enclosure, the tabs adapted to fracture upon a change in pressure within the enclosure to allow the pressure relief plate to open and thereby to allow pressure to be directed and escape from the enclosure responsive to the change in pressure within the enclosure.

13. The enclosure of claim 12, wherein:
the tabs are disposed between openings formed in the pressure relief plate; and
a width of the tabs as measured between two of the adjacent openings is between 0.05 inches and 0.07 inches.

14. The enclosure of claim 12, comprising a removable utility enclosure secured to a side of the enclosure and adapted to route pressure towards the pressure relief plate responsive to the change in pressure within the enclosure.

15. The enclosure of claim 12, wherein:
the gasket is adapted to tear upon opening of the pressure relief plate responsive to the change in pressure within the enclosure; and
the gasket comprises a top surface and a bottom surface closest to the opening, the bottom surface comprising an adhesive to secure the gasket to the top plate.

16. The enclosure of claim 12, wherein the top plate is adapted to protect live conductors within the enclosure upon opening of the pressure relief plate responsive to the change in pressure within the enclosure.

17. An enclosure, comprising:
an opening;
a top plate disposed over the opening comprising a plurality of perforated openings; and
a pressure relief plate disposed over the top plate and comprising tabs that secure the pressure relief plate to the enclosure, the tabs adapted to fracture upon a change in pressure within the enclosure to allow the pressure relief plate to open and thereby to allow pressure to be directed and escape from the enclosure responsive to the change in pressure within the enclosure.

18. The enclosure of claim 17, wherein:
the tabs are disposed between openings formed in the pressure relief plate; and
a width of the tabs as measured between two of the adjacent openings is between 0.05 inches and 0.07 inches.

19. The enclosure of claim 17, comprising a gasket disposed between the top plate and the pressure relief plate, wherein:
the gasket is adapted to tear upon opening of the pressure relief plate responsive to the change in pressure within the enclosure; and
the gasket comprises a top surface and a bottom surface closest to the opening, the bottom surface comprising an adhesive to secure the gasket to the top plate.

20. The enclosure of claim 17, comprising a removable utility enclosure secured to a side of the enclosure and adapted to route pressure towards the pressure relief plate responsive to the change in pressure within the enclosure.
